(19) United States
(12) Patent Application Publication
(10) Pub. No.: US 2004/0196599 A1
(43) Pub. Date: Oct. 7, 2004

(54) Battery for portable electronic device

(75) Inventor: Jong-Boo Kim, Suwon (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-Si (KR)

(21) Appl. No.: 10/743,304

(22) Filed: Dec. 23, 2003

(30) Foreign Application Priority Data
Dec. 28, 2002 (KR) 2002-86119

(51) Int. Cl. H02H 7/00

(52) U.S. Cl. 361/18

(57) ABSTRACT

A portable electronic device having a body having a first contact protrusion and a second contact protrusion at a side for receiving an external power supply, and a third contact protrusion for receiving a power status, and a battery device having a first contact terminal, a second contact terminal and a third contact terminal for connecting with the first to third contact protrusions of the body to provide the body with the power supply and the power status. The battery device has the first and the second contact terminals which are longer than the third contact terminal in a first direction and a second direction by a predetermined distance, respectively, to maintain the first and second contact terminals in contact with the respective contact protrusions longer than the third contact terminal.

### CROSS-REFERENCE TO RELATED APPLICATIONS

This application claims the benefit of Korean Patent Application No. 2002-86119 filed Dec. 28, 2002 in the Korean Intellectual Property Office, the disclosure of which is incorporated herein by reference.

### BACKGROUND OF THE INVENTION

1. Field of the Invention

The present invention relates to a battery for a portable electronic device, and more particularly, it relates to a battery device which does not cause a mal function of the portable electronic device during mounting and dismounting with respect to the portable electronic device.

2. Description of the Related Art

Generally, a portable electronic device is provided with a thin removable battery device. Such a battery device usually includes a terminal providing the portable electronic device with the power status, and negative and positive terminals supplying power to the electronic device.

Being very compact in size, the portable electronic device usually employs a RAM as a storage device because it consumes less power than other types of storage devices. However, RAM loses all the stored information when the power is cut off.

FIG. 1 is a block diagram of a mobile phone, as one example of the conventional portable electronic device. As shown, the mobile phone includes an input unit 1, a display unit 2, a microprocessor 3, a RAM 4, a flash ROM 5, a regulator 6, a system bus 7, a battery 8 and a backup battery 9.

The input unit 1, the display unit 2, the microprocessor 3, the RAM 4, the flash ROM 5 and the regulator 6 are connected through the system bus 7, and are driven by the power applied from the battery 8. The regulator 6 regulates the power supply to a predetermined level, and accordingly, when the supply power from the battery 8 is lower than the predetermined level, for example 3.3V, the regulator 6 adjusts the low supply power to the predetermined level, for example 3.3V. When the battery 8 has been discharged, the regulator 6 is supplied with the power from the built-in backup battery 9 to drive the mobile phone. Usually, the backup battery 9 has a shorter power supply time and smaller power capacity than the battery 8, and is mainly used to store the data of the RAM 4 in the flash ROM 5 when the battery 8 has been discharged or separated from the mobile phone. A signal (signal_l) is connected to the positive voltage (+) of the battery 8, and when the battery 8 is connected with the portable electronic device, the positive voltage (+) is supplied to the regulator 6. When the battery 8 is removed from the electronic device, the positive voltage (+) of “high” logic cannot be fed to the regulator 6, and accordingly, the regulator 6 recognizes that the battery 8 has been removed from the electronic device. Accordingly, when the signal_{—1} becomes “low”, the regulator determines that the battery 8 has been removed from the portable electronic device or is discharged, and drives the portable electronic device with the power supplied from the backup battery 9. The signal_2 shown in FIG. 1 is to provide notice to the microprocessor 3 to stop the on-going process, when the battery 8 has been discharged or removed. In other words, in order to make sure that the backup battery 9 built in the mobile phone works properly when the battery 8 is removed from the mobile phone or discharged, the signal_1 has to be fed to the regulator 6 prior to the power cut-off.

FIG. 2 is a perspective view of the conventional mobile phone and battery. Referring to FIG. 2, the conventional mobile phone includes a body 10, a holding button 11, a back surface 12 and contact protrusions 13, 14, 15, 16. The battery 20 includes first to fourth contact terminals 21˜24.

The holding button 11 secures the battery 20 to the body 10 so that the battery 20 can be securely placed on the back surface 12 of the body 10. The first and the second contact terminals 21, 22 output positive and negative voltages from the battery 20, while the third and the fourth contact terminals 23, 24 output the information about removal of the battery 20 from the body 10 and the voltage status of the battery 20.

The contact protrusions 13˜16 mate with the first to fourth contact terminals 21˜24, and being connected, the contact protrusions 13˜16 receive a signal (not shown) for detecting positive (+) and negative (−) voltages from the battery 20 and the removal of the battery 20, and a signal (not shown) for sensing the status of the battery 20. The contact protrusions 13˜16 are plated or have high tension so as to ensure that the contact protrusions 13˜16 are securely connected with the contact terminals 21˜24. The contact terminals 13˜16 employed in the battery 20 for the mobile phone are all formed the same size. Accordingly, as the contact protrusions 13, 16 for power supply are disconnected from the contact terminals 21, 22 the contact protrusion 14 for battery removal detection is also disconnected from the contact terminal 23. When the battery 20 is removed, the arrangement of these contact terminals and protrusions often results in the mobile phone not being able to recognize the removal of the battery. Accordingly, the mobile phone cannot switch power to the backup battery (not shown) built in the mobile phone in time to prevent data loss.

Furthermore, as the battery 20 is repeatedly connected to, and disconnected from the mobile phone, the contact protrusions 13˜16 lose tension or have deformation at the plating. When this happens, the contact protrusion 14 for battery removal detection is disconnected prior to the disconnection of the contact protrusions 13, 16 for positive (+) and negative (−) voltage reception, and as a result, the mobile phone does not recognize the removal of the battery 20 and thus does not switch the power to the backup battery (not shown). Accordingly, data loss occurs in the mobile phone.

### SUMMARY OF THE INVENTION

Accordingly, it is an aspect of the present invention to improve data maintenance in a portable electronic device and also to prevent mal function of the portable electronic device, by providing a battery device which has a longer contact time between a contact terminal for receiving a power from the battery and a contact protrusion, compared to a contact time between a contact terminal for sensing the status of the battery and the contact protrusion.

In order to achieve the above aspects and/or other features of the present invention, a battery device for a portable electronic device is provided. In a portable electronic device which has a body having a first contact protrusion and a second contact protrusion at a side for receiving an external power supply, and a third contact protrusion for receiving a power status; and a battery device having a first contact terminal, a second contact terminal and a third contact terminal for connecting with the first to third contact protrusions of the body to provide the body with the power supply and the power status. The battery device has the first and the second contact terminals which are longer than the third contact protrusion of the body of the portable electronic device in a first direction and a second direction by a predetermined distance, respectively.

Additional aspects and/or advantages of the invention will be set forth in part in the description which follows and, in part, will be obvious from the description, or may be learned by practice of the invention.

In an aspect of the present invention the first direction is a direction along which the first contact protrusion is connected with the first contact terminal.

The second direction is opposite to the first direction in which the first contact protrusion and the first contact terminal are connected with each other.

The second contact terminal is shorter than the first contact terminal in the first direction and in the second direction by a predetermined distance, respectively.

The first contact terminal and the second contact terminal are formed wider than the third contact terminal by a predetermined area.

### BRIEF DESCRIPTION OF THE DRAWINGS

These and/or other aspects and advantages of the invention will become apparent and more readily appreciated from the following description of the embodiments taken in conjunction with the accompanying drawings in which:

FIG. 1 is a block diagram of a conventional mobile phone;

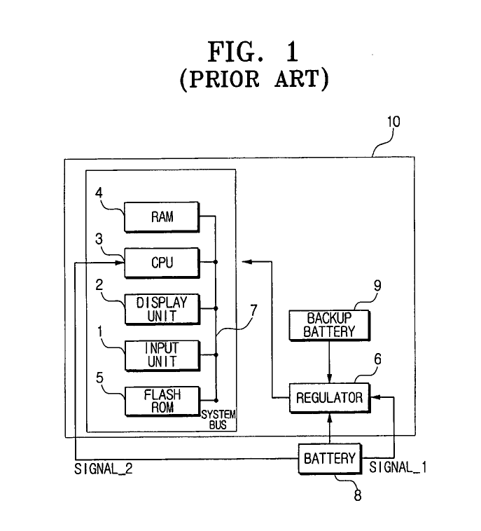

FIG. 2 is a perspective view of the conventional mobile phone and its battery;

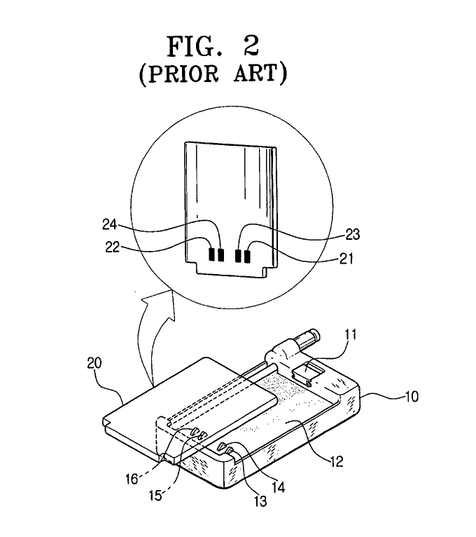

FIG. 3 is a front view of a battery device according to an embodiment of the present invention;

FIG. 4 is a perspective view illustrating the battery device according to an embodiment of the present invention being mounted on a portable electronic device;

FIG. 5 is a view illustrating the battery device according to an embodiment of the present invention being removed from the portable electronic device; and

FIGS. 6A to 6D are views illustrating the contact structures for removal/connection of the battery device, FIGS. 6A and 6B being of the conventional battery device and FIGS. 6C and 6D of the battery device according to an embodiment of the present invention.

### DETAILED DESCRIPTION OF THE EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

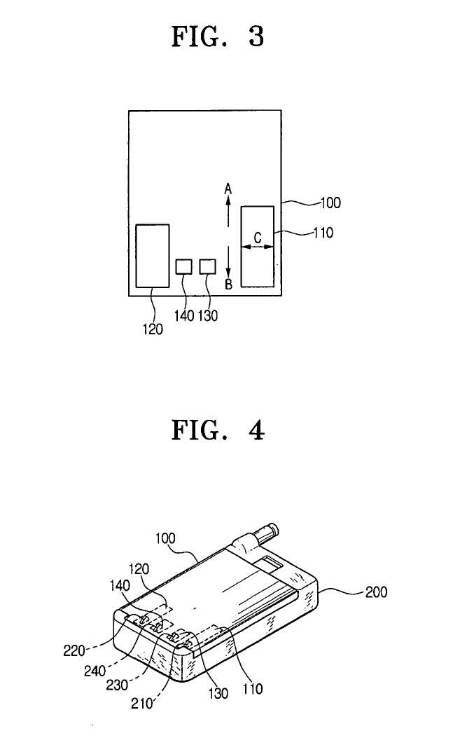

FIG. 3 is a view illustrating a battery device according to an embodiment of the present invention. Referring to FIG. 3, the battery device 100 according to the present invention includes a first contact terminal 110, a second contact terminal 120, a third contact terminal 130 and a fourth contact terminal 140. The first contact terminal 110 outputs negative voltage (−) from the battery 100. The second contact terminal 120 outputs a positive voltage (+) from the battery 100. The third contact terminal 130 outputs a positive voltage (+) from the battery 100, which will be used not for the power supply purpose, but as a signal for recognizing connection/removal of the battery 100. The fourth contact terminal 140 outputs voltage status of the battery 100.

As shown, the first contact terminal 110 is longer than the second, the third or the fourth contact terminal 120, 130, 140 by a predetermined distance in A and B directions. The first contact terminal 110 has a wider width than the third or the fourth contact terminal 130, 140 in the C direction by a predetermined distance. According to the above-described structure, the negative voltage (−) is the last to be disconnected during the removal of the battery 100 from the portable electronic device.

The second contact terminal 120 is longer than the third contact terminal 130 or the fourth contact terminal 140 in the A and B directions by a predetermined distance, while the second contact terminal 120 is shorter than the first contact terminal 110. The width of the second contact terminal 120 in the C direction is equal to, or smaller than the first contact terminal 110. According to this structure, the second contact terminal 120 is disconnected prior to the disconnection of the first contact terminal 110, while the second contact terminal 120 is not disconnected earlier than the disconnection of the third and the four contact terminals 130, 140. In the portable electronic device, the negative voltage (−) is usually used as the reference voltage, and accordingly, it is beneficial that the negative voltage (−) is disconnected later than the disconnection of the positive voltage (+). It is understood that the arrangement may be swapped if the positive voltage (+) needs to be disconnected later than the negative voltage (−).

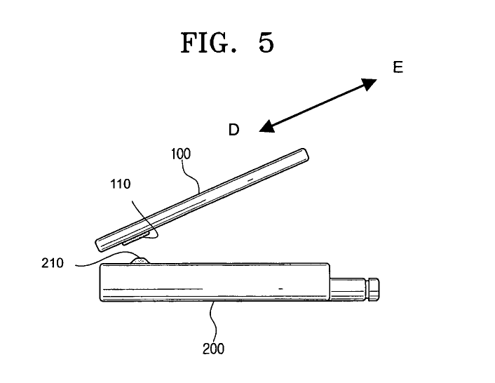

FIG. 4 is a perspective view illustrating the battery device being connected to the portable electronic device 200, for example, a mobile phone. Referring to FIG. 4, the first contact protrusion 210, the second contact protrusion 220, the third contact protrusion 230 and the fourth contact protrusion 240 of the portable electronic device 200 are connected with the first contact terminal 110, the second contact terminal 120, the third contact terminal 130 and the fourth contact terminal 140, respectively. The contact area and contact length between the first contact terminal 110 and the first contact protrusion 210 are the largest, and the contact area and the contact length between the second contact terminal 120 and the second contact protrusion 220 are the second largest. The contact area and the contact length between the third contact terminal 130 and the third contact protrusion 230 are the third largest, and accordingly, the contact area and the contact length between the fourth contact terminal 140 and the fourth contact protrusion 240 are the smallest. In another aspect the third and fourth contact area and length are the same size.

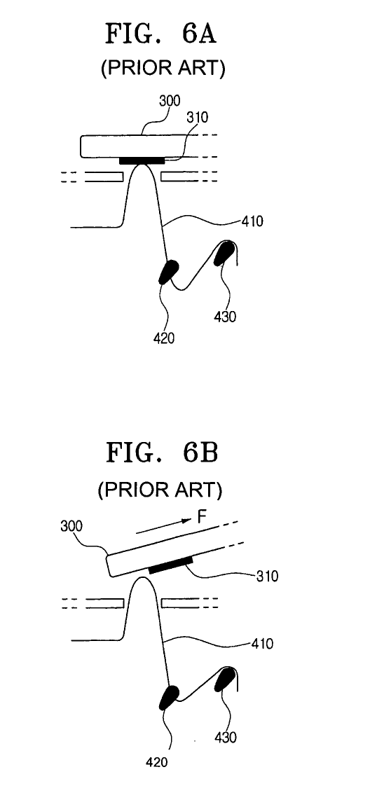

FIG. 5 is a view illustrating the battery device 100 being removed from the portable electronic device 200. As shown, the battery device 100 is usually made to slide into/out of the portable electronic device 200. In FIG. 5, the first contact protrusion 210 and the first contact terminal 110 are shown, and the battery device 100 is connected with the electronic device in the D direction, and disconnected from the electronic device in the E direction. It is understood that though the battery pack is depicted as attaching to the portable electronic device with an arc motion, other configurations that use the contact terminals of different lengths are possible. For example, a portable electronic device that uses a battery pack that slides into place would also benefit from the configuration of contact terminals in this embodiment.

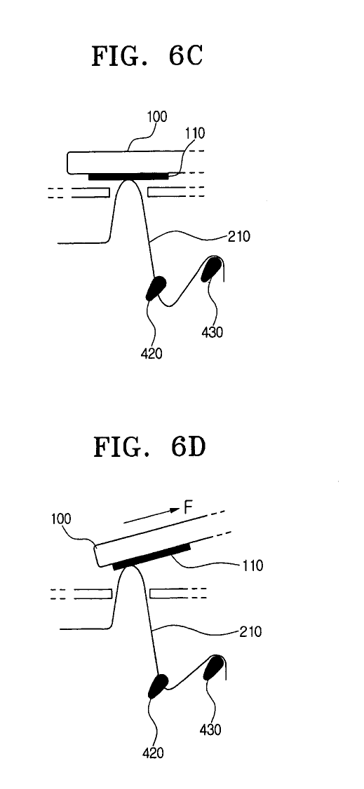

FIGS. 6A and 6B are sectional views showing the connecting/disconnecting of the conventional battery device with respect to the portable electronic device (not shown), while FIGS. 6C and 6D are sectional views showing the battery device according to an embodiment of the present invention being connected/disconnected with respect to the portable electronic device.

First, FIG. 6A shows the contact protrusion 410 for the reception of negative voltage (−) supply, and the contact terminal 310 of the battery device, in which the contact protrusion 410 and the contact terminal 310 are connected with each other. The reference numerals 420 and 430 are pins for securing the contact protrusion 410 in the electronic device.

FIG. 6B shows the contact protrusion 410 and the contact terminal 310 when the battery device 300 of FIG. 6A is removed from the portable electronic device. As the battery device 300 is moved in the F direction, the contact protrusion 410 and the contact terminal 310 are disconnected. Although not shown, the other contact terminals for outputting the signal to indicate positive voltage (+), the negative voltage (−) and the removal of the battery device, are all the same size as the contact terminal 310 and the contact protrusion 410, and thus, they are disconnected at the same time that the contact terminal 310 and the contact protrusion 410 are disconnected from each other.

FIG. 6C is a view illustrating the contact protrusion 210 for reception of negative voltage (−) supply and the contact terminal 110 of the battery device 100, in which the contact protrusion 210 and the contact terminal 110 are connected with each other. The contact terminal 110 is longer than the contact terminal 410 of FIG. 6A by a predetermined distance.

FIG. 6D is a view illustrating the contact protrusion 210 and the contact terminal 110 when the battery device 100 of FIG. 6C is in the process of being removed from the portable electronic device. As shown, when the battery device 100 is moved in the F direction, the contact protrusion 210 and the contact terminal 110 remain in the connected state. The contact terminal 110 is for receiving the negative voltage (−). Though not shown, the contact terminal for receiving positive voltage (+) and the terminal for outputting the signal to indicate removal of battery device 100, which are shorter than the contact terminal 110, are disconnected. As a result, as the battery device 100 is removed from the portable electronic device, the signal that indicates the battery removal to the portable electronic device is disconnected first, and then the terminal for positive voltage (+) is disconnected, and lastly, the terminal for negative voltage (−) terminal is disconnected. Accordingly, enough time can be ensured from the removal of the battery device 100 until switching of the power source to the built-in backup battery (not shown) to prevent data loss.

Referring to FIGS. 6A and 6B, the contact protrusion 410 is elastically deformable. When the battery device 300 is removed in the F direction, the contact protrusion 410 extends toward the battery device 300 as the contact protrusion 410 returns to an uncompressed state. The longer contact terminal 110, as illustrated in FIGS. 6C and 6D, maintains communication with the contact protrusion 210 for a longer period of time when the battery device 100 is removed in the F direction as compared to the smaller uniform contact terminal 310, illustrated in FIG. 6B.

According to the present invention, by varying the shape of the contact terminals of the battery device, sufficient time is ensured for switching the power source to the backup battery in case of battery removal, and as a result, mal function of the portable electronic device is prevented and data of the portable electronic device is preserved. It is understood that though the invention was described with reference to a mobile phone, the invention may be used with other types of portable electronic devices with battery packs, such as GPS units and PDAs, etc.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A battery device for a portable electronic device, wherein the portable electronic device comprises a body having a first contact protrusion and a second contact protrusion at a side for receiving an external power supply, and a third contact protrusion for receiving a power status; and the battery device having a first contact terminal, a second contact terminal and a third contact terminal for connecting with the first to third contact protrusions of the body to provide the body with the power supply and the power status,
the battery device having the first and the second contact terminals which are longer than the third contact terminal in a first direction and a second direction by first and second predetermined distances, respectively.

2. The battery device for the portable electronic device of claim 1, wherein the first direction is along which the first contact protrusion is connected with the first contact terminal.

3. The battery device for the portable electronic device of claim 2, wherein the second direction is opposite to the first direction in which the first contact protrusion and the first contact terminal are connected with each other.

4. The battery device for the portable electronic device of claim 3, wherein the second contact terminal is shorter than the first contact terminal in the first direction and in the second direction by third and fourth predetermined distances, respectively.

5. The battery device for the portable electronic device of claim 4, wherein the first contact terminal and the second contact terminal are formed wider than the third contact terminal by predetermined width distances.

6. A power source apparatus comprising:
a battery pack having a connector to interface with an electronic device, wherein the connector comprises,
first and second contact terminals to supply power from the battery to the electronic device through corresponding contact protrusions of the electronic device, and a plurality of auxiliary contact terminals to interface with the electronic device through corresponding contact protrusions of the electronic device, wherein the first and second contact terminals have a predetermined contact area that is larger than an area of the plurality of auxiliary contact terminals.

7. The apparatus of claim 6, wherein the first contact terminal has a first predetermined contact area that is larger than a second predetermined contact area of the second contact terminal, and the first and second predetermined contact areas are larger than the area of the plurality of auxiliary contact terminals to maintain communication between the first and second contact terminals and the corresponding contact protrusions until after the plurality of auxiliary contact terminals lose communication during a battery removal process.

8. The apparatus of claim 7, wherein the first contact terminal is longer than the second contact terminal in a direction from a center point of the first contact terminal along a direction of insertion of the battery pack, and the second contact terminal is longer than the plurality of auxiliary contact terminals in a direction from a center point of the second contact terminal along the direction of insertion of the battery pack.

9. The apparatus of claim 7, wherein the first and the second contact terminals have predetermined widths that are larger than a width of the plurality of auxiliary contact terminals in a direction orthogonal to a direction of the battery pack insertion.

10. The apparatus of claim 6, further comprising a first auxiliary contact terminal and a second auxiliary contact terminal; wherein, the first contact terminal, the second contact terminal and the first auxiliary contact terminal and the second auxiliary contact terminal each having different predetermined lengths to control an order of communication with respective contact protrusions during battery pack removal and insertion.

11. The apparatus of claim 6, wherein an end of the electronic device closest to the contact protrusions defines a pivot axis, wherein a near end of the first contact terminal and a near end of the second contact terminal are closer to the pivot axis than a near end of the plurality of auxiliary contact terminals when the battery pack is inserted and removed.

12. The apparatus of claim 11, wherein the near end of the first contact terminal is closer to the pivot axis than the near end of the second contact terminal, which is closer to the pivot axis than the near end of the plurality of auxiliary contact terminals.

13. The apparatus of claim 6, wherein the first power contact terminal supplies negative voltage and the second power contact terminal supplies positive voltage.
